(19) United States
(12) Patent Application Publication
(10) Pub. No.: US 2024/0319518 A1
(43) Pub. Date: Sep. 26, 2024

(54) MODULAR EYEWEAR DEVICES, SYSTEMS, AND KITS

(71) Applicants: Diepriye Stephen Orubo, Houston, TX (US); Ngozi Ebere Orubo, Houston, TX (US); Uzoma Chidi Amuneke, Houston, TX (US); Obinna Chiaka Amuneke, Houston, TX (US)

(72) Inventors: Diepriye Stephen Orubo, Simpsonville, SC (US); Ngozi Ebere Orubo, Simpsonville, SC (US); Uzoma Chidi Amuneke, Cypress, TX (US); Obinna Chiaka Amuneke, Houston, TX (US)

(21) Appl. No.: 18/547,216

(22) PCT Filed: Mar. 2, 2022
(86) PCT No.: PCT/US2022/018566

§ 371 Date: Aug. 21, 2023

Related U.S. Application Data
(60) Provisional application No. 63/155,773, filed on Mar. 3, 2021.

(51) Int. Cl. G02C 5/02; G02C 5/22; G02C 11/00

(52) U.S. Cl. CPC G02C 5/02; G02C 5/22; G02C 11/10; G02C 2200/02; G02C 2200/04; G02C 2200/08

(57) ABSTRACT

Modular eyewear frames, modular eyewear, and modular eyewear devices with improved durability, customization, and functionality. An eyewear frame is comprised of components that are reversibly connected at one or more connections that are configured to fail such that the components are not broken and may be reassembled for continued use of the frame. Components of the frame may be disconnected and interchanged with other components to create frames with certain appearances or functionalities. A modular eyewear device may be configured for use with a computer system and may be provided as part of a kit that includes interchangeable components or accessories.

### CROSS-REFERENCE TO RELATED APPLICATIONS

The present application claims priority from and is a PCT application of U.S. Provisional Application No. 63/155,773, entitled “Modular Eyewear Devices, Systems, and Kits” filed 3 Mar. 2021, the entire contents of which are herein incorporated by reference for all purposes.

### FIELD

The disclosure relates to eyewear frames and devices that are assembled and configured for detachment at one or more connections such that frame components are not broken and may be reassembled for continued use. Components may be disconnected and reconnected, with different combinations of components, to customize appearances or functionalities of the frames.

### BACKGROUND

Framed consumer and industrial eyewear, such as corrective or prescription glasses, reading glasses, sunglasses, protective glasses, and specialty eyewear devices, are worn by individuals for the many advantages they provide. These products may improve visual acuity, reduce glare due to natural or artificial light, protect the eyes and face from injury, or augment the wearer's view of their surroundings, for example, as part of a recreational or non-recreational augmented reality (AR) system. The frames secure the lenses and other components and enable the eyewear to be stably worn on the face.

In many instances, framed eyewear products may be dropped, stepped on, or otherwise stressed or strained due to external forces, to the point of breakage of the frame. This necessitates replacement or repair of the frame (or eyewear, device, or product), and may increase risk of breakage of the lenses or other components. The cost and inconvenience of replacing or repairing the frames may discourage the use of the eyewear. Similarly, electronic devices with framed eyewear form factors, such as devices with AR, navigation, or audiovisual functionalities, may be expensive to replace or repair. These expenses may be passed on to the consumer, either as increased direct payments to repair professionals or device vendors for repair or replacement of the device, respectively, or as increased insurance premiums or out-of-pocket expenses in connection with an insurance claim. These considerations may discourage the widespread adoption of these technologies.

Framed eyewear is also not easily customizable. Disassembly and reassembly of the framed eyewear with desired combinations of components, for example, to create desired styles or functionalities, is inconvenient and requires specific tools and knowledge. An individual may need to hire a professional eyewear technician for such customization, whose services may be costly. In some instances, if the framed eyewear is not desirably styled but is otherwise functional, the individual may forego alteration of the eyewear altogether due to cost considerations.

Accordingly, there is a need for improved framed eyewear devices and form factors that are modular, durable, and customizable with regard to form and function. The present disclosure addresses this unmet need.

### SUMMARY

The present disclosure provides improved frames for eyewear and eyewear devices, improved framed eyewear and framed eyewear devices, and computational and electronic systems that include, utilize, or are utilized by improved framed eyewear devices. The present disclosure also provides kits that include a frame, a framed eyewear, or a framed eyewear device of the disclosure, as well as methods for making and using the frame, the framed eyewear, and the framed eyewear device. The methods may include steps that utilize features or elements of a frame, an eyewear device, and/or a computational or electronic system.

Generally, the disclosure provides modular eyewear frames that may be incorporated into an eyewear form factor, such as a framed eyewear (e.g., glasses) or a framed eyewear device (e.g., AR glasses). The frames are designed to survive external forces and impacts by the inclusion of attachable frame components that reliably detach, at defined places, such that the frame components are not broken and may be reassembled to reproduce the frame for continued use. The frames may also be intentionally disassembled and reassembled to create desired appearances or functionalities based on desired combinations of frame components as part of personalization or customization of the frames.

In various aspects, the disclosure provides an eyewear frame, comprising a first frame component and a second frame component that are reversibly connectable at a connection. When the first frame component is connected to the second frame component at the connection and an external force of sufficient magnitude is applied to the frame, the first frame component disconnects from the second frame component at the connection. If the external force may be characterized in that it would have damaged or destroyed a different eyewear frame, such as a prior eyewear frame, then an advantage is that the frame components of the improved frame do not undergo excessive stress or strain and are not damaged or destroyed by the external force. If, on the other hand, the external force may be characterized in that it is part of an intentional disassembly of the frame. such as may occur as part of customization or modification of the improved frame, then an advantage of the disconnection is that the components may be easily disconnected and reassembled for customization of the frames without the need for specialized tools or knowledge. Accordingly, the present disclosure provides improved modular eyewear frames with multiple uses and advantages.

In various other aspects, the disclosure provides eyewear, eyewear devices, and eyewear systems that make use of or incorporate an eyewear frame of the disclosure with an aspect of the eyewear, eyewear device, or eyewear system. For example, an eyewear may be in the form of a pair of corrective or prescription glasses having an eyewear frame of the disclosure as part of the design. Similarly, an eyewear device may be in the form of a pair of augmented reality (AR) glasses having an eyewear frame of the disclosure as part of the design or device form factor. Along the same lines, an eyewear system may include or be configured to interact with an eyewear device that includes an eyewear frame of the disclosure as part of the design or device form factor of the eyewear device. The disclosure also provides kits that are configured for effectively storing and transporting frames, eyewear, and eyewear devices of the disclosure.

### BRIEF DESCRIPTION OF THE DRAWINGS

FIG. 1A depicts a front view of a different eyewear frame (e.g., a prior eyewear frame) with an external force applied that causes stress or strain at a bridge.

FIG. 1B depicts a front view of breakage of the different eyewear frame at the bridge.

FIG. 2A depicts a top view of the different eyewear frame with the external force applied that causes stress or strain at the bridge.

FIG. 2B depicts a top view of breakage of the different eyewear frame at the bridge.

FIG. 3A depicts a top view of the different eyewear frame with an external force applied that causes stress or strain at a temple connection.

FIG. 3B depicts a top view of breakage of the different eyewear frame at the temple connection.

FIG. 4A depicts a front view of an improved eyewear frame of the present disclosure (e.g., a modular eyewear frame) with an external force applied that causes stress or strain at a bridge connection.

FIG. 4B depicts a front view of disconnection of the frame at the bridge connection.

FIG. 4C depicts a front view of the frame, reassembled after disconnection at the bridge connection.

FIG. 5A depicts a top view of the frame with an external force applied that causes stress or strain at left and right temple connections.

FIG. 5B depicts a top view of disconnection of the frame at the left and right temple connections.

FIG. 5C depicts a top view of the frame, reassembled after disconnection at the left and right temple connections.

FIG. 6A depicts a front view of an improved eyewear frame with a left lens frame connected to a right lens frame at a bridge connection.

FIG. 6B depicts a front view of the frame disconnected at the bridge connection and introduction of an alternate left lens frame.

FIG. 6C depicts a front view of the frame with the alternate left lens frame connected to the right lens frame at the bridge connection.

FIG. 7A depicts a top view of an improved eyewear frame with a left temple connected to a left lens frame at a left temple connection and a right temple connected to a right temple frame at a right temple connection.

FIG. 7B depicts a top view of the frame disconnected at the left temple connection and the right temple connection and introduction of an alternate left temple and an alternate right temple.

FIG. 7C depicts a top view of the frame with the alternate left temple connected to the left lens frame and the alternate right temple connected to the right lens frame.

FIG. 8A depicts a perspective view of a framed eyewear of the present disclosure, in an assembled state.

FIG. 8B depicts a first perspective view of the framed eyewear in a disassembled state.

FIG. 8C depicts a second perspective view of the framed eyewear in the disassembled state, with a focus on a bridge connection and a right temple connection.

FIG. 8D depicts an enlarged second perspective view of the framed eyewear in the disassembled state, with a detailed focus on the bridge connection and the right temple connection.

FIG. 9 depicts a front view of the framed eyewear with an inset showing a partial cross-section of an exemplary center bridge and bridge connection.

FIG. 10A depicts a front cross-sectional view of a first center bridge, disconnected.

FIG. 10B depicts a front cross-sectional view of the first center bridge, connected.

FIG. 11A depicts a front cross-sectional view of a second center bridge, disconnected.

FIG. 11B depicts a front cross-sectional view of the second center bridge, connected.

FIG. 11C depicts a front cross-sectional view of an alternate second center bridge, connected.

FIG. 11D depicts a front cross-sectional view of another alternate second center bridge, connected.

FIG. 12A depicts a front cross-sectional view of a third center bridge, disconnected.

FIG. 12B depicts a front cross-sectional view of the third center bridge, connected.

FIG. 12C depicts a front cross-sectional view of an alternate third center bridge, connected.

FIG. 12D depicts a front cross-sectional view of another alternate third center bridge, connected.

FIG. 13A depicts a front cross-sectional view of a left member of a left lens frame and a right member of a right lens frame, disconnected.

FIG. 13B depicts a front cross-sectional view of the left member of the left lens frame and the right member of the right lens frame, connected.

FIG. 14A depicts a top exploded view of a framed eyewear of the present disclosure.

FIG. 14B depicts a top cross-sectional view of a left temple stub.

FIG. 14C depicts a top cross-sectional view of a left temple groove.

FIG. 14D depicts a side view of the left temple groove.

FIG. 14E depicts a top cross-sectional view of the left temple stub engaged with the left temple groove.

FIG. 15A depicts a front view of the framed eyewear with internal structures shown in broken lines.

FIG. 15B depicts a left side view of the framed eyewear with internal structures shown in broken lines.

FIG. 16 depicts a perspective view of a first container for a first kit of the present disclosure.

FIG. 17A depicts a top view of a second container and a second kit of the present disclosure, with a lower tray opened.

FIG. 17B depicts a top view of the second container and the second kit, with the lower tray opened and an upper tray opened.

FIG. 17C depicts a perspective view of the second container and the second kit, with the lower tray opened.

FIG. 17D depicts a perspective cross-sectional view of the second container and the second kit, with the lower tray opened.

FIG. 17E depicts an exploded perspective view of the second container and the second kit.

FIG. 18A depicts a top view of a travel container of a kit of the present disclosure.

FIG. 18B depicts a left side view of the travel container.

FIG. 18C depicts a front side view of the travel container, with a lid in a closed configuration.

FIG. 18D depicts a front side view of the travel container, with the lid in an open configuration.

FIG. 18E depicts a front side view of a first alternate travel container, with a first alternate lid in a first alternate open configuration.

FIG. 18F depicts a front side view of a second alternate travel container, with a second alternate lid in a second alternate open configuration.

FIG. 19A depicts a perspective view of a first form factor of improved framed eyewear of the present disclosure.

FIG. 19B depicts a perspective view of a second form factor of improved framed eyewear of the present disclosure.

FIG. 19C depicts a perspective view of a third form factor of improved framed eyewear of the present disclosure.

FIG. 19D depicts a perspective view of a fourth form factor of improved framed eyewear of the present disclosure.

FIG. 19E depicts a perspective view of a fifth form factor of improved framed eyewear of the present disclosure.

FIG. 19F depicts a perspective view of a sixth form factor of improved framed eyewear of the present disclosure.

FIG. 20 depicts a schematic of exemplary electronic elements of an improved framed eyewear device and/or improved framed eyewear system of the present disclosure.

Although characteristic features of the invention will be particularly pointed out in the claims, exemplary embodiments of the invention and manners in which they may be made and used may be better understood after a review of the following description, taken in connection with the accompanying drawings, wherein like numeral annotations are provided throughout.

### DETAILED DESCRIPTION

Reference is made herein to the attached drawings. Like reference numerals may be used in the drawings to indicate like or similar elements of the description. The figures are intended for representative purposes, are not drawn to scale, and should not be considered limiting.

### I. Definitions

Unless otherwise defined herein, terms and phrases used in connection with the present disclosure shall have the meanings that are commonly understood by those of ordinary skill in the art.

As used in the description and in the claims, the terms “comprising” and “comprises” do not exclude other elements or steps. The terms “consisting essentially of” and “consists essentially of” limit the scope of a claim to the specified elements or steps and those that do not materially affect the basic and novel characteristics of the claimed invention. The terms “consisting of” and “consists of” exclude any element or step not specified in a claim.

Where a reference is made to a singular noun, whether with or without use of an indefinite or definite article (e.g., “a”, “an”, or “the”), this includes a plural of that noun unless something else is specifically stated. Furthermore, the terms first, second, third, and the like in the description and in the claims, are used for distinguishing between elements and not necessarily for describing a sequential or chronological order. It is to be understood that the terms so used are interchangeable under appropriate circumstances and that the implementations of the disclosure described herein are capable of operation in other sequences than described or illustrated herein.

As used herein, the term “about” refers to the usual error range for the respective value readily known to the skilled person in this technical field. Reference to “about” a value or parameter herein includes and describes implementations and embodiments that are directed to that value or parameter per se.

As used herein, the term “frame” refers to a structure configured to be worn on the face of a wearer, for any purpose, either alone or as an element of an eyewear, an eyewear device, or an eyewear system.

As used herein, the term “eyewear” refers to a structure configured to be worn on the face of the wearer for improving, adjusting, or augmenting an aspect of the wearer's vision, and which does not include an electronic or electric element; examples of eyewear include, but are not limited to corrective glasses, prescription glasses, reading glasses, sunglasses, and protective glasses.

As used herein, the term “eyewear device” refers to a structure configured to be worn on the face of the wearer for improving, adjusting, or augmenting an aspect of the wearer's vision, and which does include an electronic or electric element; examples of eyewear devices include, but are not limited to augmented reality (AR) devices, virtual reality (VR) devices, navigation devices, audio devices, graphical display devices, audiovisual devices, night vision devices, infrared (IR) vision devices, light-emitting devices, sound-emitting devices, flashlight devices, image recording devices, video recording devices, audio recording devices, audiovisual recording devices, and entertainment devices.

As used herein, the term “eyewear system” refers to two or more elements that are configured to communicate or interoperate with each other, at least one of which is an eyewear device; examples of eyewear systems include, but are not limited to AR systems, VR systems, navigation systems, global positioning systems (GPS), cloud-based content storage and delivery systems, and entertainment systems.

### II. Eyewear Frames and Devices

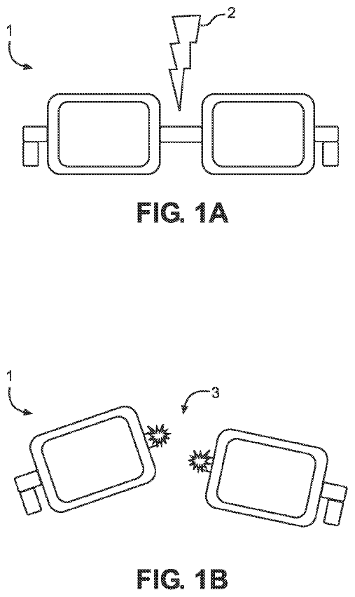

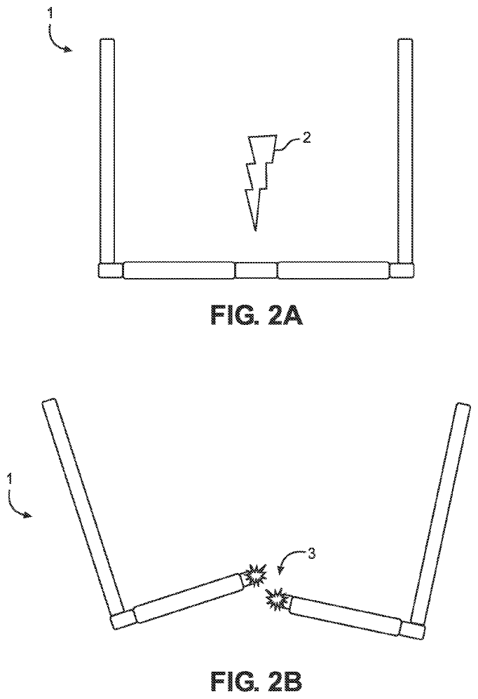

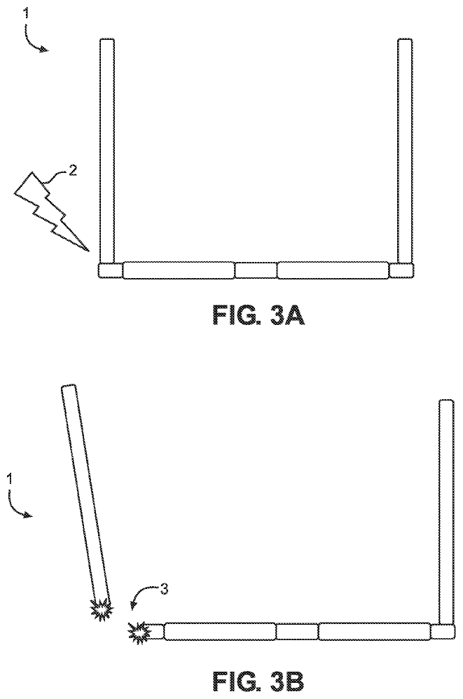

Different eyewear frames (e.g., prior eyewear frames), as may be utilized with prior eyewear and prior eyewear devices, are generally unyielding and susceptible to breakage when the frames undergo stress or strain that result from external forces. As shown in FIGS. 1A, 1B, 2A, and 2B, one location where breakage of a different eyewear frame 1 occurs is the bridge, which in response to an external force 2 applied at any portion of the different frame 1, causes the bridge to break apart 3. The different frame 1 must then be repaired or replaced for continued use. Another location where breakage of the different frame 1 occurs is the temple connection. As shown in FIGS. 3A and 3B, in response to an external force 2 applied at any portion of the different frame 1, the temple connection breaks apart 3. Again, the different frame 1 must then be repaired or replaced.

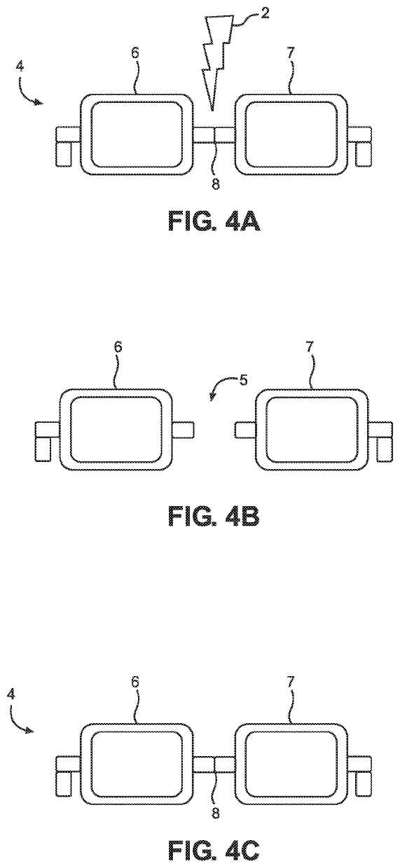

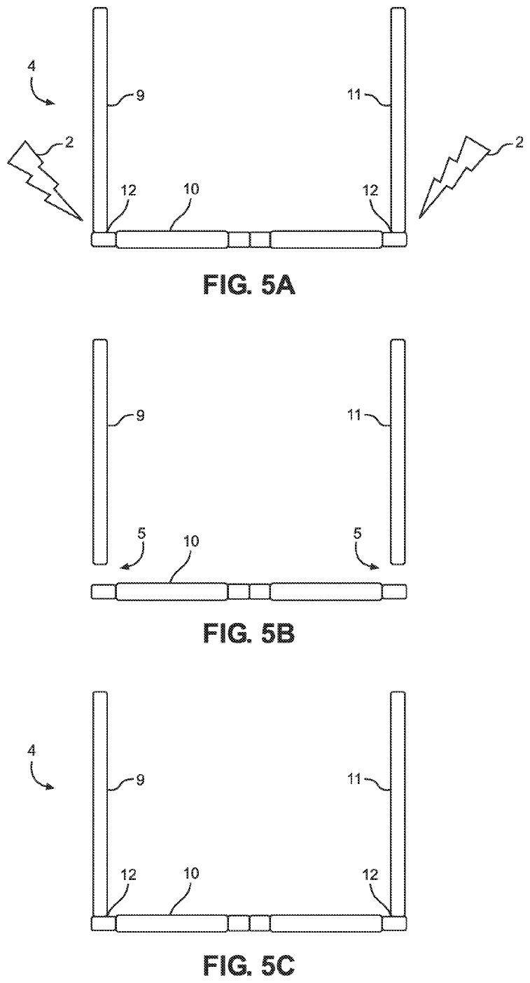

In general, one advantage of the frames and devices of the disclosure is their ability to controllably yield and reversibly “break” in response to applied external forces, such that the overall structural integrity of the frames is maintained, and the frames can be easily reassembled and used. As shown in FIGS. 4A, 4B, and 4C, a generic modular frame 4 is modularly designed and assembled for use, but when an external force 2 is applied to any portion of the frame 4, as shown in FIG. 4A, it may cause the bridge to controllably break apart 5, resulting in a separation of a left lens frame 7 from a right lens frame 6 at a bridge connection 8 of the frame 4, as shown in FIG. 4B. Because the frame 4 is modular and designed to break apart in this manner, the bridge connection 8 can be restored easily, after the breakage, to reconnect the left lens frame 7 with the right lens frame 6 and reassemble the frame 4 for continued use, as shown in FIG. 4C. Similarly, as shown in FIGS. 5A, 5B, and 5C, when an external force 2 is applied to any portion of the frame 4, controlled breakage 5 of the frame 4 at temple connections 12 occurs, resulting in separation of a right temple 9 from a lens frame 10 and separation of a left temple 11 from the lens frame 10, as shown in FIG. 5B. Like the bridge connection, the temple connections 12 can be easily restored, after the breakage, by reconnecting the left temple 11 to the lens frame 10 and the right temple 9 to the lens frame 10 to reassemble the frame 4 for continued use, as shown in FIG. 5C.

By controllably “breaking” at one or more connections in response to the external force, the maximum stresses and strains experienced by components of the improved frame are lower than they would be for a different frame or a prior frame which would generally be rigid and non-modular, and therefore more susceptible to breakage compared to the improved frames disclosed herein. As a result, the components of the improved frames are not damaged or broken and the probability of their being able to be reused is increased. This is because the stresses and strains may be greater than levels needed to break the connections but less than levels needed to damage or destroy the components of the frame, such as the lens frames and the temples. In this manner, if the improved frame is dropped or stepped on such that there would be an increased risk of damage to a different eyewear frame (e.g., a prior eyewear frame), the improved frame of the disclosure can controllably break down and be easily reassembled for continued use without the need for specialized tools, equipment, or expertise.

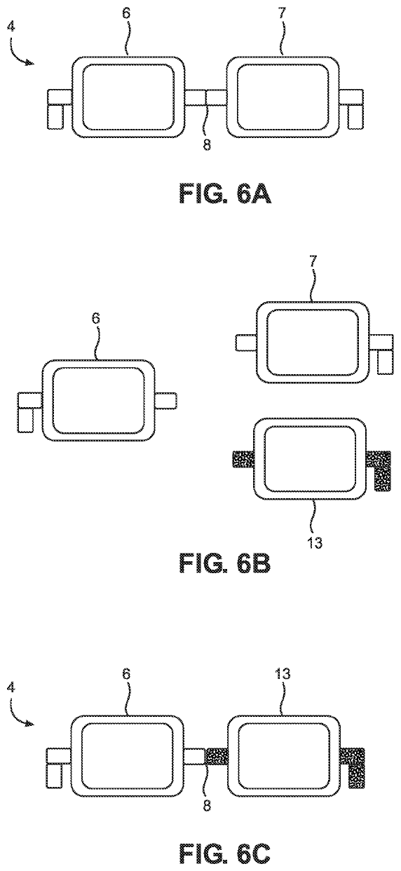

Another improvement of the frames of the present disclosure is their ability to be disassembled and reassembled for modification or customization of the appearance or function of the frames or eyewear, eyewear device, or eyewear system that incorporates the frames. Referring now to FIG. 6A, a generic modular frame 4 may include a bridge connection 8 that connects a left lens frame 7 with a right lens frame 6. An individual, such as a user or a wearer, may intentionally disassemble the frame 4 at the bridge connection 8, and swap out the left lens frame 7 for an alternate left lens frame 13, as shown in FIG. 6B, which may then be connected with the right lens frame 6 at the bridge connection 8, as shown in FIG. 6C. The combination of the right lens frame 6 and the alternate left lens frame 13 may impart a different style or appearance, or a different functionality or feature, which may not have been present or apparent with the combination of the right lens frame 6 and the left lens frame 7.

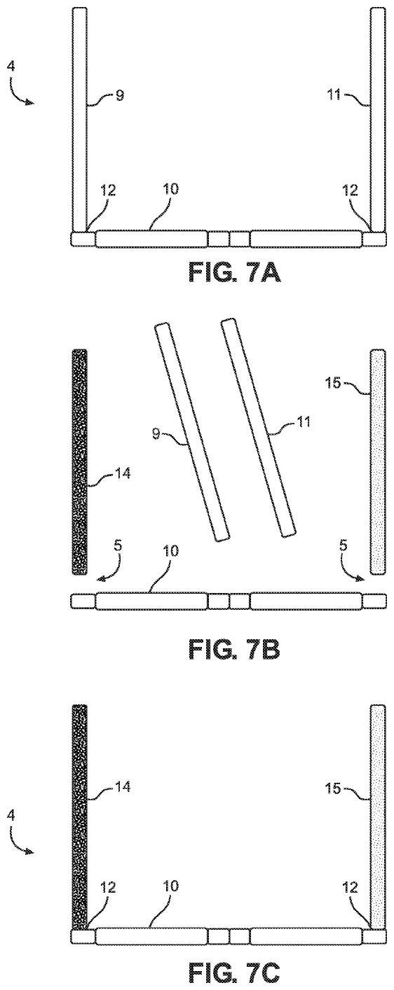

Similarly, in various embodiments of the frame 4, the temples may be swapped out. As shown in FIGS. 7A, 7B, and 7C, the right temple 9 and the left temple 11 may each be disconnected 5 from the lens frame 10 at temple connections 12, and the right temple 9 and left temple 11 swapped out for an alternate right temple 14 and an alternate left temple 15, which may then be connected to the lens frame 10, as shown in FIG. 7C. The combination of the alternate right temple 14 and the alternate left temple 15 with the lens frame 10 may impart a particular style or appearance, or a particular functionality or feature, which may not have been present or apparent with the combination of the right temple 9 and the left temple 11 with the lens frame 10. In various instances, by enabling the individual to easily control customization and modification of the frame 4, the individual may be more inclined to modify the frame 4 to achieve a certain style or functionality, even if the modification is voluntary or the frame 4 was partially or completely functional before the modification. In this manner, the frame 4 may be used for many different modifications for many different purposes.

In many instances, modifications to the frame may be voluntary and may involve style modifications to impart particular appearances to the frame or may involve functional modifications to impart particular functionalities to the frame. Exemplary style modifications include swapping out frame components with different shapes, colors, or designs. An example of a design may be a 2D or 3D image embedded within a component of the frame which produces a certain optical effect; another example of a design may be a form of visual and/or audio art of a component of the frame. Exemplary functional modifications include repairing the frame by replacing a damaged or destroyed frame component with a replacement frame component, maintenance, replacement, or upgrade of a frame component or an electronic frame component or element such as a software element or a firmware element or a power source (e.g., replacement of a depleted power source with a recharged power source or a replacement power source), introduction of a new functionality such as addition of an augmented reality (AR) element to an eyewear or eyewear device without it, and removal of an old functionality. Frames, eyewear, devices, and systems with different appearances and/or functionalities may be achieved by disassembling two or more components, swapping out one or more old components for one or more new components, and assembling the new combination of frame components.

a. Frame Components

Components of a frame of the disclosure include any two or more parts of the frame which, when properly connected, form the frame or a portion of the frame. In some implementations the only reversible connection is the bridge connection, and the frame components are the left and right halves of the frame on either side of the bridge. In other implementations the only reversible connections are the temple connections, and the frame components are the two temples and the lens frame, such that the left temple connects to a left lens frame of the lens frame and the right temple connects to a right lens frame of the lens frame. In still other implementations and as shown in many instances in the present disclosure, the frame includes the bridge connection, the left temple connection, and the right temple connection, and the frame components include the left temple, the left lens frame, the right lens frame, and the right temple.

Additional frame components may be included in embodiments for advantages or features these components provide; these may include, but are not limited to a center bridge, a left temple stub, and a right temple stub. The center bridge, when present, may be configured as a passive sleeve that covers a direct connection between the left lens frame and the right lens frame (or elements or members thereof) or, alternatively, may be configured as an active element of an indirect connection between the left lens frame and the right lens frame which interacts with the left lens frame and the right lens frame separately and acts as an intermediate link to connect these structures. The left and right temple stubs, when present, may be configured to reversibly engage with left and right temple grooves of the left and right temples, respectively, as shown and described herein.

While certain implementations or embodiments of exemplary frames are explicitly shown or described herein, it is generally intended that the disclosure encompass and include other, broader implementations or embodiments of the frames, such as those that may include a subset of the total features or components explicitly shown or described for the exemplary frames.

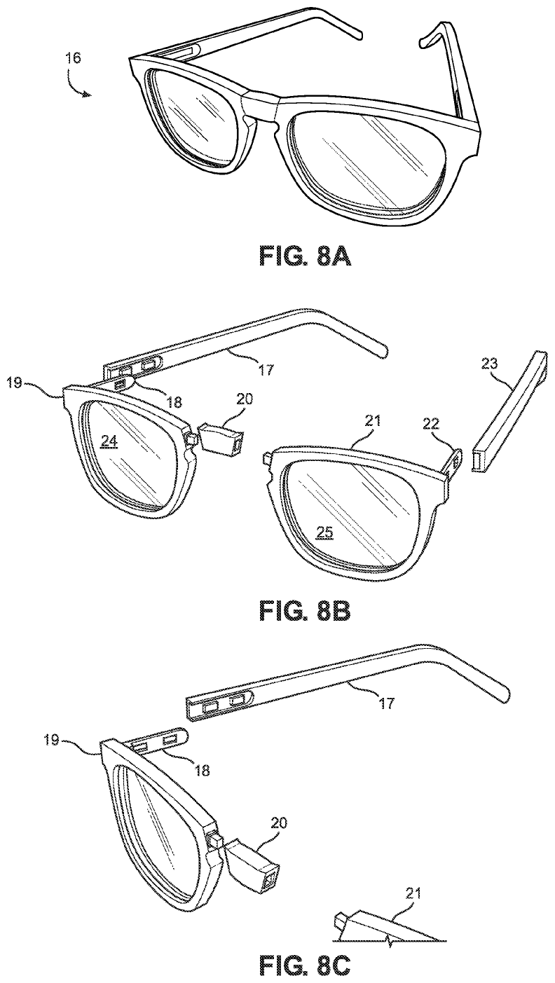

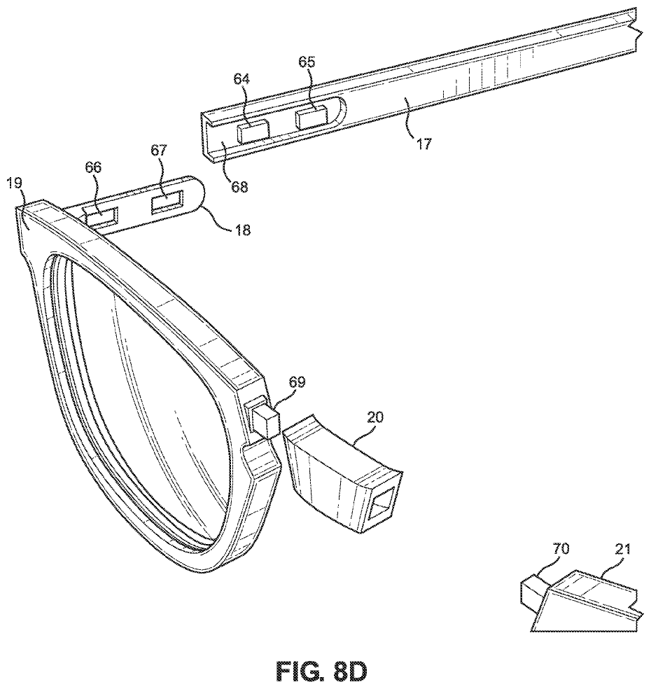

An exemplary improved modular eyewear frame 16 is shown at FIG. 8A. The frame 16 can be disassembled, as shown at FIGS. 8B and 8C, such that a right temple 17 is disconnected from a right temple stub 18, a right lens frame 19 is disconnected from a center bridge 20, the center bridge 20 is disconnected from a left lens frame 21, and a left temple stub 22 is disconnected from a left temple 23. Any one or more of these disconnections could be made at any given time, either as part of a yielding of the frame 16 in response to an external force, or as part of an intentional disassembly of the frame 16 by an individual. In the shown embodiment the frame 16 holds a left lens 25 and a right lens 24, however, the lenses 25, 24 may be optional or omitted in a particular embodiment or configuration. The frame 16 is comprised of a set of components that includes the right temple 17, the right temple stub 18, the right lens frame 19, the center bridge 20, the left lens frame 21, the left temple stub 22, and the left temple 23.

In various embodiments, the lenses 24, 25 may be non-prescription glass, prescription glass, non-prescription plastic, prescription plastic, or any combination thereof. The lenses 24, 25 may be comprised of shade or tint materials, transition glasses or materials, or plastic materials. The frame 16 may be incorporated into safety eyewear, sports eyewear, or utility eyewear. In embodiments, the frame 16 may comprise a plurality of center bridges 20, a plurality of left lens frames 21, a plurality of right lens frames 19, a plurality of left temples 23, and/or a plurality of right temples 17. In general, the frame 16 may be customized by interchanging one or more components thereof.

Referring now to FIG. 8D, there is shown an enlarged second perspective view of the framed eyewear in the disassembled state. The right temple 17 may be reversibly connected to the right temple stub 18 by inserting the right temple stub 18 into a right temple groove 68, and insertion of right temple members 64 and 65 through right temple stub apertures 66 and 67, respectively. The right temple groove 68 may be sized and shaped to conform with the size and shape of the right temple stub 18 to stabilize the temple connection and prevent rotational movement of the right lens frame 19 relative to the right temple 17 about the pitch axis, roll axis, and yaw axis.

While not shown in the figure, the left temple includes a left temple groove, which may be sized and shaped to conform with a left temple stub in like manner as that shown for the right temple connection. The left temple groove in like manner includes members for insertion through left temple stub apertures to stabilize the temple connection and prevent rotational movement of the left lens frame 21 relative to the left temple about the pitch axis, roll axis, and yaw axis.

The center bridge 20 is shown as being configured to accept a right male member 69 of the right lens frame 19 and a left male member 70 of the left lens frame 21 into corresponding female acceptors of the center bridge 20. The engagements between the right male member 69 and the right female acceptor of the center bridge 20, and the left male member 70 and the left female acceptor of the center bridge 20, may utilize any suitable mode of connection, and may be configured such that the left and right lens frames 21, 19 are unable to rotate (e.g., about the pitch axis) relative to each other. This may be achieved by use of certain cross-sectional shapes for the male members (69, 70) and the corresponding female acceptors. In the shown embodiment this is accomplished with complementary square or rectangular 4-pointed cross sectional shapes, however, other suitable cross-sectional shapes may be used, including but not limited to 3-pointed shapes, 5-pointed shapes, 6-pointed shapes, ovular shapes, or irregular shapes, among others, without departing from the scope of the disclosure. These engagements may be stabilized by other structures that may not rely on a cross-sectional shape, such as non-rotational interfaces or gear interfaces, or alternatively, may be stabilized by the connection type used for the engagement.

b. Component Connections

In various instances, the components of the frame may be reversibly connected using one or more modes of connection (MOC). The MOC for a particular embodiment may be selected based on its ability to hold the connection or frame in an assembled state when the frame is being worn and gently used, and to disconnect when the frame is dropped, stepped on, or roughly used, such that the components disconnect and are not damaged or destroyed. Any MOC may be used for a particular implementation if suitable, including but not limited to a mechanical MOC, a magnetic MOC, a hook-and-loop MOC, an adhesive MOC, an adhesive tape MOC, and an electromagnetic MOC. Examples of a mechanical MOC include but are not limited to a button snap MOC, a male-female mating MOC, and a complementary mating MOC. An electromagnetic MOC may be used such that a magnetic field is activated or deactivated in response to an electrical signal that is activated or deactivated and, when activated, is controllably delivered from a power source to an electromagnet. A magnetic MOC may utilize one or more ferromagnetic materials.

In certain instances, the MOC may assist the user with assembly of the frame components, and this may be an advantage gained with a magnetic MOC or an electromagnetic MOC. In this case, the components may be magnetic or electromagnetic complements that are attracted to each other. For example, a first component may include a member with a first magnetic field and a second component may include a member with a second magnetic field, and the first and second magnetic fields may be oppositely signed (i.e., positive-negative, or negative-positive). The first component member is magnetically attracted to the second component member, and vice versa, such that the components are drawn together in space and are more easily connected by the individual to form the connections between the frame components. Assisted connection of frame components, as may be achieved with magnets or electromagnets, may be desirable in instances where the connections would otherwise require a degree of visual acuity, dexterity, or cognitive focus which may be difficult to attain for some individuals or in some instances.

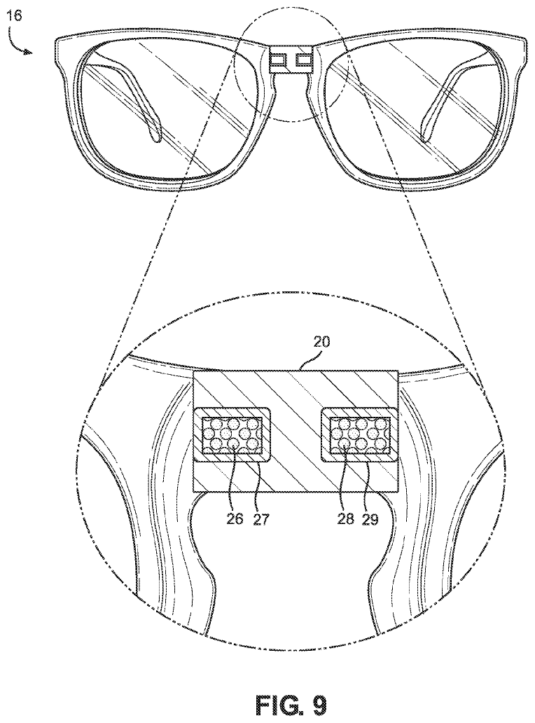

Referring now to FIG. 9, there is shown a frame 16 with an inset showing a cross-section of a center bridge and bridge connection. The center bridge 20 may include a magnetic bridge right female acceptor 27 and a magnetic bridge left female acceptor 29 configured to reversibly receive a magnetic right lens frame male member 26 that extends from the right lens frame and a magnetic left lens frame male member 28 that extends from the left lens frame, respectively. While shown and described as involving mechanical and/or magnetic MOC at various places in the disclosure, the component connections may involve any suitable MOC, generally may or may not be shown to scale, and are generally configured to be easily disconnected in the event of an external force or an intentional disassembly.

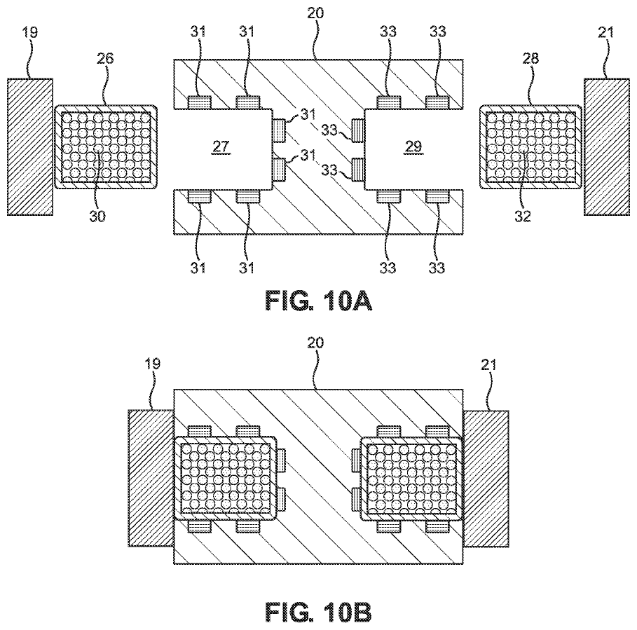

Referring now to FIGS. 10A and 10B, there are shown a cross-sectional view of a first center bridge, disconnected (FIG. 10A) and connected (FIG. 10B) with an indirect magnetic bridge connection. The right lens frame 19 and the left lens frame 21 may be reversibly and indirectly connected with each other via a center bridge 20. A magnetic right lens frame male member 26 that extends from the right lens frame 19 may be inserted into a magnetic bridge right female acceptor 27 of the center bridge 20, and a magnetic left lens frame male member 28 that extends from the left lens frame 21 may be inserted into a magnetic bridge left female acceptor 29 of the center bridge 20. In the shown embodiment, the right male member 26 is or includes therein magnetic right lens frame male member element 30 and the left male member 28 is or includes therein magnetic left lens frame male member element 32. The center bridge 20 includes magnetic bridge right female acceptor element 31 that are magnetically complementary to the right male magnetic element 30, and also includes magnetic bridge left female acceptor element 33 that are magnetically complementary to the left male magnetic element 32.

Any of various magnetic element configurations and arrangements may be used to form the indirect magnetic bridge connection. The right female magnetic elements 31 and the left female magnetic elements 33 may be opposite poled (e.g., positive-negative, or negative-positive, respectively), and the right male magnetic element 30 and the left male magnetic element 23 may also be opposite poled (e.g., negative-positive, or positive-negative, respectively). In certain implementations, an alternating pole arrangement may be used for the indirect magnetic connection. For example, a central magnetic element (not shown) may be embedded within a middle portion of the center bridge 20, between the left female acceptor 29 and the right female acceptor 27, such that a right portion of the central magnetic element is magnetically complementary with the right male magnetic element 30 and a left portion of the central magnetic element is magnetically complementary with the left male magnetic element 23. Similarly, while the male members (26, 28) are shown as extending from the lens frames (19, 21) and the center bridge 20 receives the male members (26, 28) at female receivers (27, 29), in alternate embodiments (not shown), the male members may extend from the center bridge and be received by female receivers of the lens frames, without departing from the scope of the disclosure.

Unless otherwise stated, a male member may be exchanged with a female receiver, and vice versa, and this male/female and female/male interchangeability and inclusivity applies to any and all male/female and female/male connections as exemplarily shown or described herein. Similarly, two or more complementary elements may be interchanged or rearranged to maintain the complementarity relationship even with different configurations or arrangements of the elements, without departing from the scope of the disclosure.

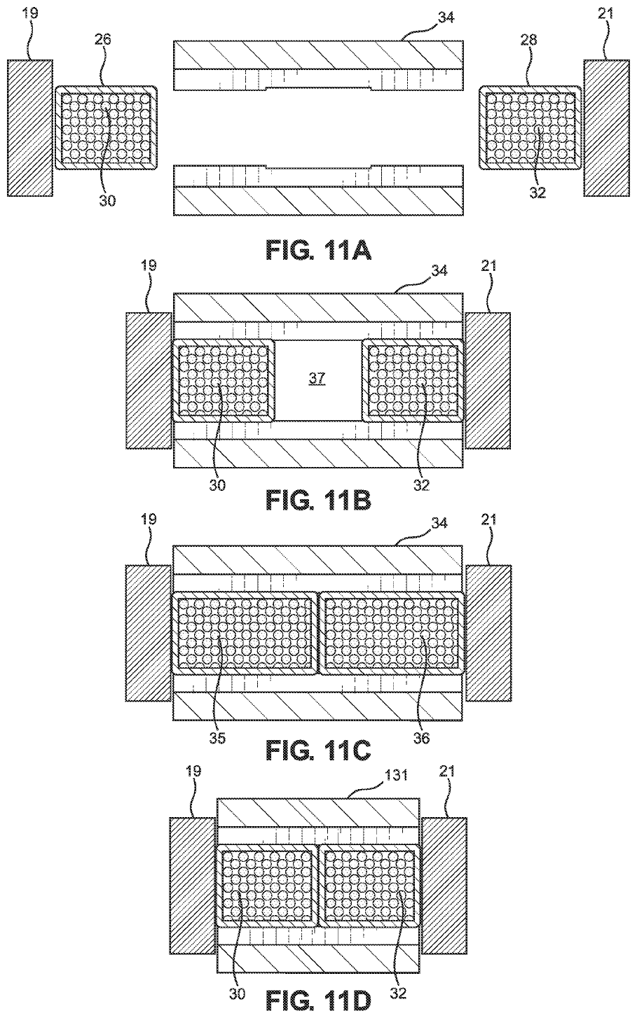

Referring now to FIGS. 11A and 11B, there are shown a cross-sectional view of a second center bridge, disconnected (FIG. 11A) and a cross-sectional view of the second center bridge, connected (FIG. 11B). The right lens frame 19 and the left lens frame 21 may be reversibly and directly connected with each other and the connection covered or obscured by a passive center bridge 34 that is configured to accommodate a direct connection between members 26, 28 of the lens frames 19, 21. As shown in FIGS. 11A and 11B, the right male member 26 that extends from the right lens frame 19 may be inserted toward a center bridge gap 37 of the passive center bridge 34, and the left male member 28 that extends from the left lens frame 21 may also be inserted toward the center bridge gap 37 of the passive center bridge 34. In the shown embodiment, the right male member 26 is or includes therein the magnetic right lens frame male member element 30 and the left male member 28 is or includes therein the magnetic left lens frame male member element 32. In the shown embodiment, the center bridge 20 passively receives the male members 26, 28 therein and does not directly participate in the connection between the male members 26, 28 which form a direct connection due to magnetic complementarity of magnetic elements 30, 32.

In the embodiment of FIG. 11B the direct connection may occur over a distance within the passive center bridge 34. This may be achieved with certain sizes or strengths of magnetic elements 30, 32, and may be advantageous if the male members need to be configured to easily disconnect from the central female acceptor. However, in other embodiments and as exemplarily shown in FIG. 11C, an elongated magnetic left lens frame male member 36 and an elongated magnetic right lens frame male member 35 may be used, which close the gap such that the greater left male member 36 and the greater right male member 35 make direct physical contact with each other. This may be beneficial for formation of a stronger direct connection between the male members 26. 28. In yet other embodiments, as shown in FIG. 11D, a shortened passive center bridge 131 may be used to cover the direct connection between the members. In this and related embodiments, the magnetic elements 30, 32 may make direct contact with each other without necessarily needing to be enlarged and may be configured for both a strong direct connection and greater case in disconnecting from the central female acceptor. Because the strength of the magnetic fields decreases with distance between the magnetic elements 30, 32, the size, strength, and positioning of the magnetic elements 30, 32 may be optimized by testing these and other parameters for a particular scenario.

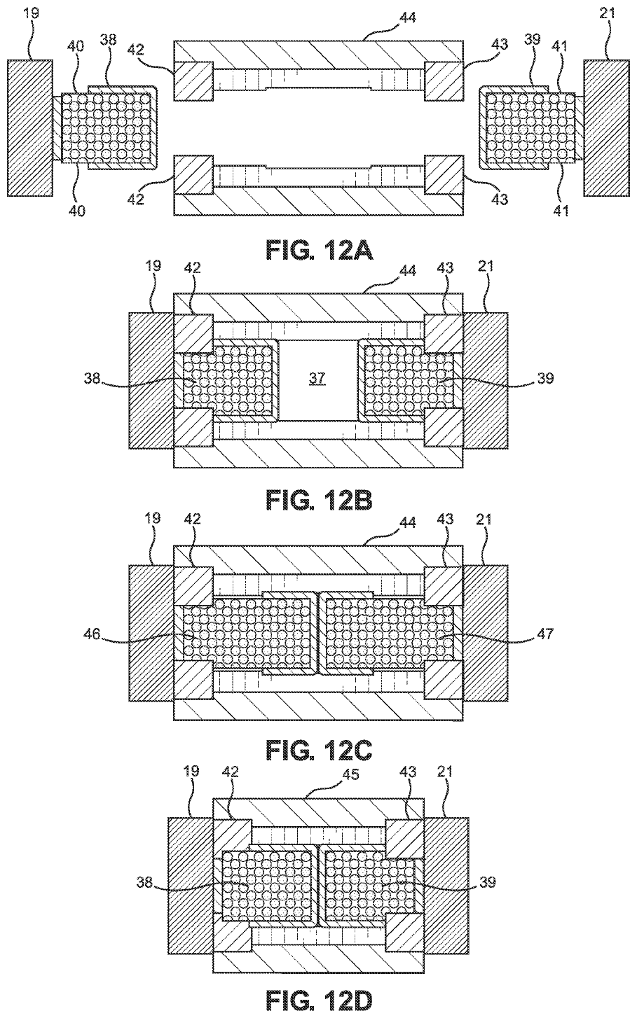

Referring now to FIGS. 12A and 12B, there are shown a cross-sectional view of a third center bridge, disconnected (FIG. 12A) and a cross-sectional view of the third center bridge, connected (FIG. 12B). The right lens frame 19 and the left lens frame 21 may be reversibly and indirectly connected with each other via a ribbed center bridge 44. As shown, a grooved right lens frame male member 38 extends from the right lens frame 19 into the center bridge gap 37 of the ribbed center bridge 44, and a grooved left lens frame male member 39 extends from the left lens frame 21 into the center bridge gap 37 of the ribbed center bridge 44. In the shown embodiment, the right male member 38 includes thereon a right male member groove 40 and the left male member 39 includes thereon a left male member groove 41. In the shown embodiment, the ribbed center bridge 44 receives the male members 38, 39 therein and the male members 38, 39 form an indirect connection with each other via the ribbed center bridge 44. As the right male member 38 enters the center bridge gap 37, a ribbed center bridge right rib 42 slides over the right male member 38, e.g., as part of a slight deformation of the ribbed center bridge 44, and snaps into a secured position over the right male member groove 40. Similarly, as the left male member 39 enters the center bridge gap 37, a ribbed center bridge left rib 43 slides over the left male member 39, e.g., as part of a slight deformation of the center bridge 44, and snaps into a secured position over the left male member groove 41.

In the embodiment of FIG. 12B, the indirect connection leaves the center bridge gap 37 open. However, in other embodiments and as exemplarily shown in FIG. 12C, an elongated grooved left lens frame male member 47 and an elongated grooved right lens frame male member 46 may be used, which are longer and configured to close the gap such that the left male member 47 and the right male member 46 make direct physical contact with each other. This may be beneficial for formation of a stronger indirect connection. As the right male member 46 enters the center bridge gap 37, a ribbed center bridge right rib 42 slides over the right male member 46, e.g., as part of a slight deformation of the center bridge 44, and snaps into a secured position over the right male member groove. Similarly, as the left male member 47 enters the center bridge gap 37, a ribbed center bridge left rib slides over the left male member 47, e.g., as part of a slight deformation of the center bridge 44, and snaps into a secured position over the left male member groove. In yet other embodiments, as shown in FIG. 12D, a shortened ribbed center bridge 45 may be used to cover the indirect connection between the member 39 of the left lens frame 21 with the member 38 of the right lens frame 19. In this embodiment, the male members 38, 39 may be able to make direct contact with each other without necessarily needing to be enlarged for a strong direct connection and ease in disconnecting from the center bridge 44. The exact size, strength, and positioning of the male members 38, 39 and the bridge ribs 42, 43 may be optimized by testing these and other parameters for a particular scenario.

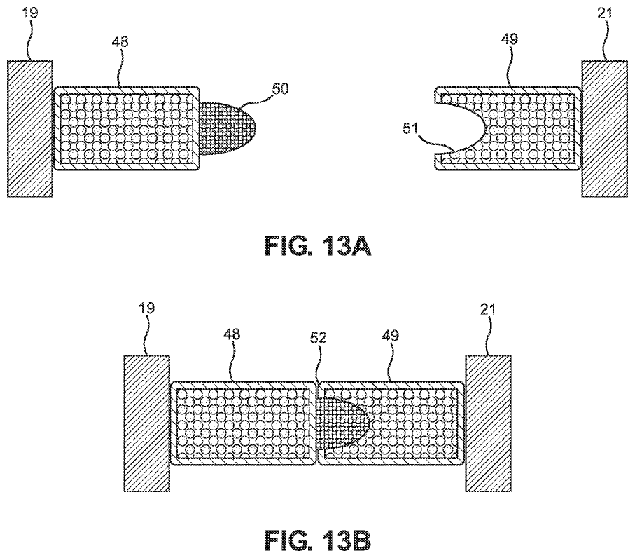

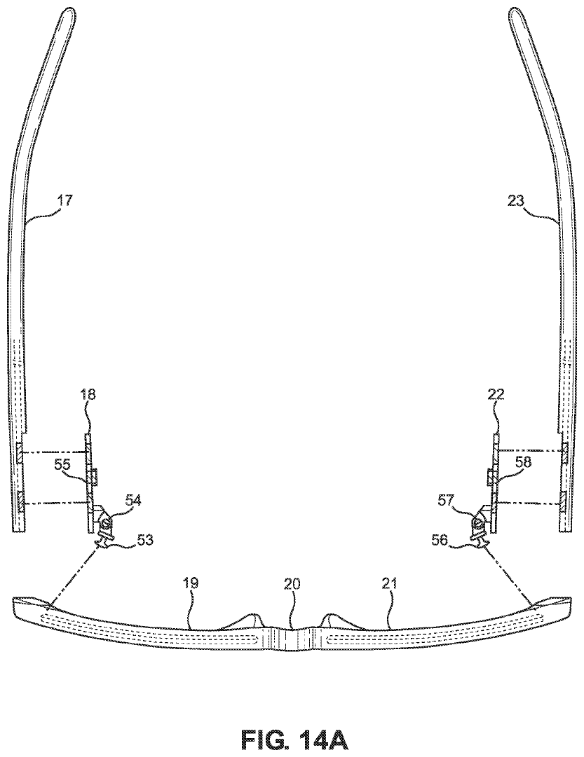

Referring now to FIGS. 13A and 13B, there are shown a left member of a left lens frame and a right member of a right lens frame, disconnected (FIG. 13A) and connected for a male-female direct bridge connection 52 (FIG. 13B). The right lens frame 19 may be connected to the left lens frame 21 by a right lens frame member male extension 50 that extends from a right lens frame member shaft of the right lens frame 19, and a left lens frame member female aperture 51 that extends from a left lens frame member shaft 49 of the left lens frame 21. The right male member 50 and the left female acceptor 51 may be mechanically or magnetically complementary.

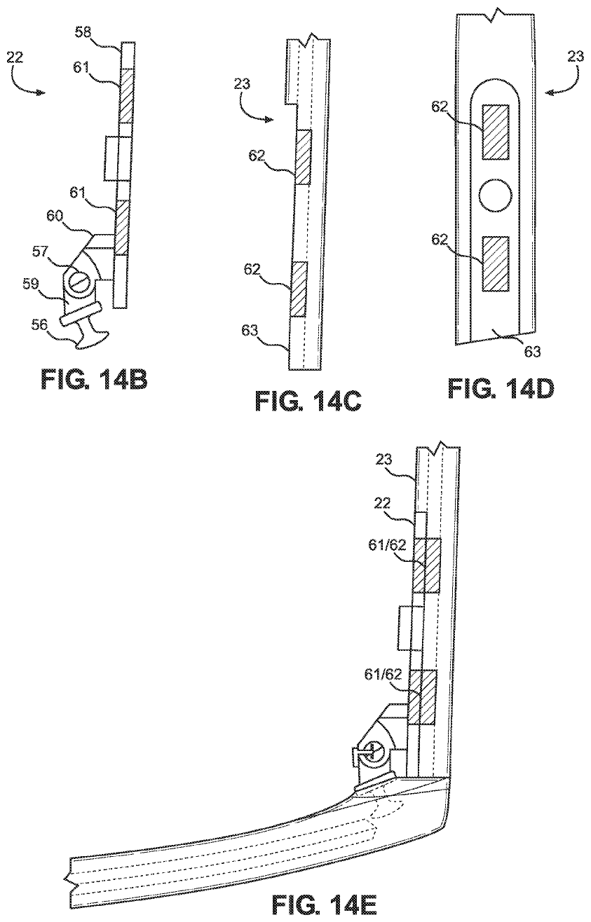

Referring now to FIG. 14A, there is shown a top exploded view of a framed eyewear of the present disclosure. The right temple 17 connects to the right lens frame 19 via the right temple stub 18, and the left temple 23 connects to the left lens frame 21 via the left temple stub 22. The right lens frame 19 is shown connected to the left lens frame 21 via the center bridge 20. The dotted lines show connections that may be made for assembly of the frame, e.g., an assembly that may be performed manually and without any need for special tools or expertise.

The right temple stub 18 includes a right temple stub connector 55 which is hingedly attached to a right temple stub anchor 53 via a right temple stub hinge 54. The right temple stub anchor 53 is embeddable within the right lens frame 19 for permanent or semi-permanent attachment thereto, and the left temple stub anchor 56 is embeddable within the left lens frame 21 for permanent or semi-permanent attachment thereto. The left temple stub 22 includes a left temple stub connector 58 which is hingedly attached to a left temple stub anchor 56 via a left temple stub hinge 57.

Assembly of the frame may involve permanent or semi-permanent attachment of the temple stubs 18, 22 to the lens frames 19, 21 prior to use of the frame. For example, in some instances from the perspective of a consumer, the temple stubs 18, 22 may have been previously attached to the lens frames 19, 21, for example, as part of production of the frame. The temples may be disconnected from the lens frames 19, 21 by detachment of the temples 17, 23 from temple stub connectors 55, 58 of the temple stubs 18, 22. These connections, which temporarily connect the temple stubs 18, 22 to the temples 17, 23, may be mechanical, magnetic, or both, or a different type of connection, including but not limited to any of the MOC shown or described herein, including any MOC that may be used for a bridge connection.

Referring now to FIGS. 14B, 14C, 14D, and 14E, there are shown a top cross-sectional view of a left temple stub (FIG. 14B), a top cross-sectional view of a left temple groove (FIG. 14C), a side view of the left temple groove (FIG. 14D), and a top cross-sectional view of the left temple stub engaged with the left temple groove (FIG. 14E). While these figures focus on the left temple connection, the right temple connection may utilize the same or similar structures, such as structures that are mirrored relative to these figures, as would be understood by a person of ordinary skill in the art. The left temple stub 22 includes left temple stub connector shaft 60, left temple stub hinge 57, and left temple stub anchor shaft 59. The left temple stub 22 may be anchored within the left lens frame as shown in FIG. 14E and is connectable to the left temple 23 by connecting left temple stub connectors 61 with left temple groove connectors 62. Left temple stub connectors 61 and left temple groove connectors 62 may be complementary structures, such as complementary magnets, as shown. The left temple stub 22 fits snugly into the left temple groove 63, as shown in FIG. 14E, and is held in place and prevented from rotating about the pitch, roll, and yaw axes relative to the left temple.

Because the left temple stub 22 is rigidly connected to the left lens frame via the left temple stub anchor 56, the left temple 23 is prevented from rotating relative to the left lens frame as well. Hinged movement of the left temple stub connector shaft 60 relative to the left temple stub anchor shaft 59 correlates with hinged movement of the left temple 23 and the left temple stub 22 relative to the left lens frame when the temple connection is assembled as shown in FIG. 14E. In this manner, the temples of the frame may be folded inward such that the frame is in a folded, compact configuration, as may be the case for other eyewear frames.

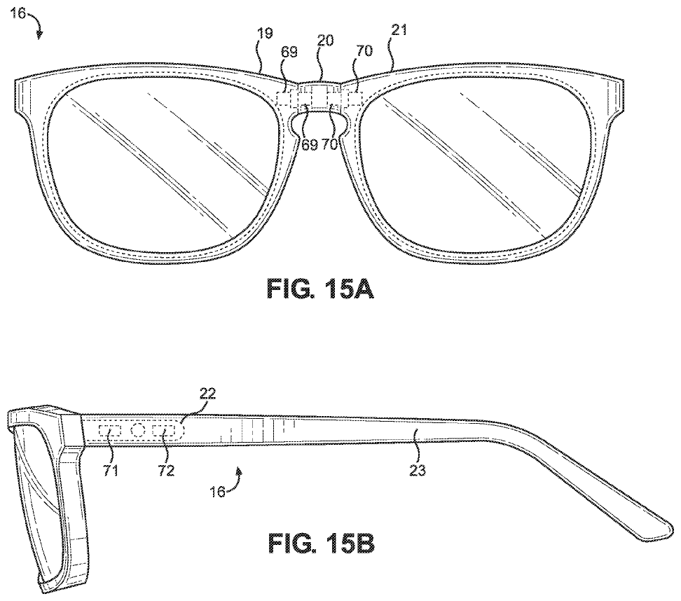

Referring now to FIGS. 15A and 15B, there are shown a front view of the framed eyewear with internal structures shown in broken lines (FIG. 15A) and a left side view of the framed eyewear with internal structures shown in broken lines (FIG. 15B). The modular frame 16 is shown with the right lens frame 19 attached to the left lens frame 21 via the center bridge 20. As shown, the right lens frame male member 69 and the left lens frame male member 70 may extend inward toward middle axes of the right lens frame 19 and the left lens frame 21, respectively. This may help stabilize the position of the members 69, 70 relative to the lens frames 19, 21. A forward left temple groove connector 71 may be proximal to the left lens frame 21, and a rear left temple groove connector 72 may be distal to the left lens frame 21. The use of multiple temple groove connectors for use with the left temple stub 22 that are aligned along a longitudinal length of the temples, may help stabilize the lens frames 19, 21 relative to the temples, including the right temple and the left temple 23, and prevent unwanted movement of the lens frames 19, 21 relative to the temples.

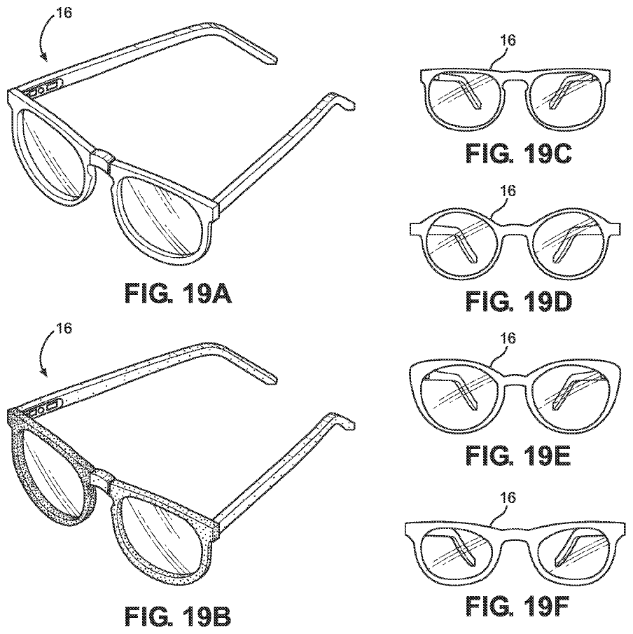

Referring now to FIGS. 19A, 19B, 19C, 19D, 19E, and 19F, there are shown perspective views of a first form factor (FIG. 19A), a second form factor (FIG. 19B), a third form factor (FIG. 19C), a fourth form factor (FIG. 19D), a fifth form factor (FIG. 19E), and a sixth form factor (FIG. 19F) of a frame of the disclosure. Any form factor may be used for the frame 16, including but not limited to the form factors shown. In certain implementations, an element of one form factor may be combined with an element of another form factor and the appearances and functionalities of various form factors may be mixed and matched to achieve a desired outcome. The selection of a particular form factor, whether an original form factor or a derivative or combinatorial form factor created by two or more elements obtained from or inspired by two or more different form factors, may be shaped by considerations related to cost, market demand, availability, materials, or suitability for use with features of an eyewear device or system.

### III. Eyewear Systems

A modular framed eyewear device of the disclosure may be an element of, or may be configured to interact with, a system that is configured for one or more electronic or computational functionalities. The system may be configured for any of various uses, including but not limited to management and delivery of notifications or telecommunications, entertainment, internet browsing, social media engagement, software applications or “apps”, recording and/or playback of photo, video, and/or audio, augmented reality (AR) games or applications, virtual reality (VR) games or applications, or a use that is not explicitly recited herein. In various instances, the system may be configured for assisting a wearer of an eyewear device with navigation. The assistance may be provided at least in part by an AR assistant, the behavior of which may be determined at least in part by a software element of the system that delivers photo, video, and/or audio content to the wearer to help the wearer navigate a space, a neighborhood, a city, a town, a state, a country, or a geographic area.

a. System Elements

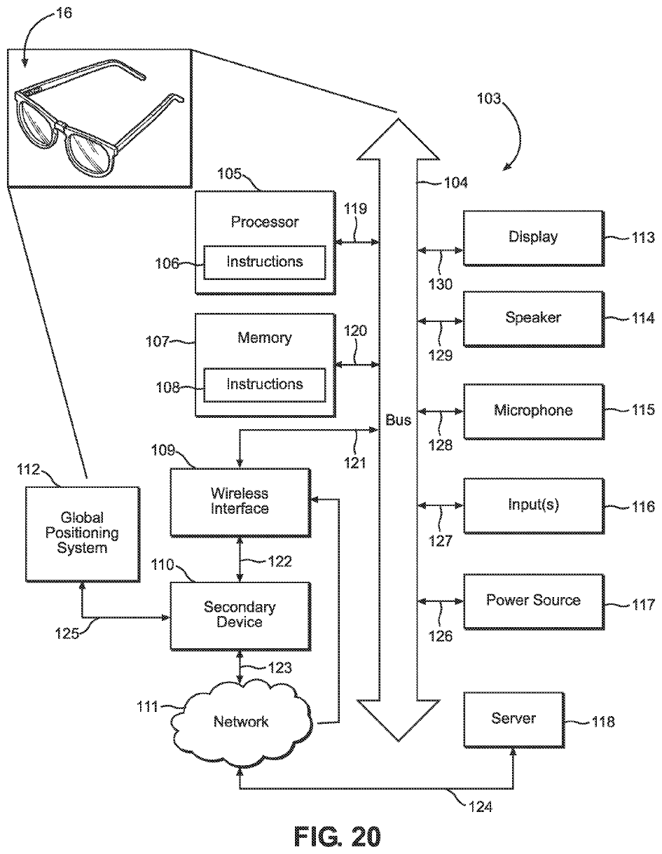

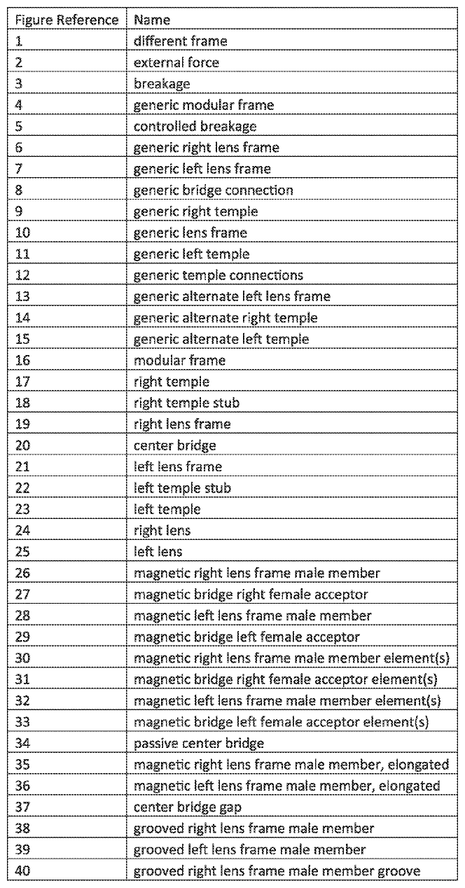

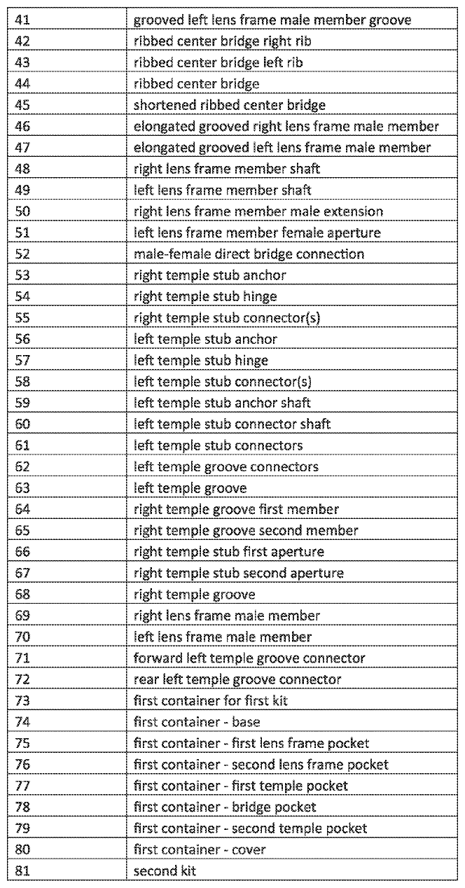

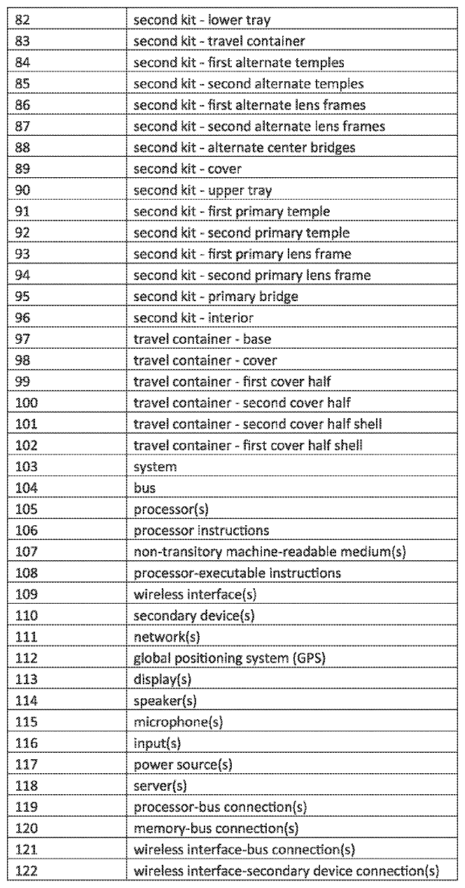

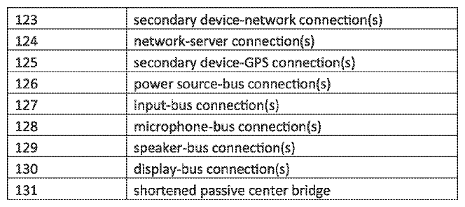

A schematic of exemplary electronic elements of an improved framed eyewear device and/or improved framed eyewear system is shown at FIG. 20. A modular frame 16 may be incorporated into a form factor of an eyewear device and the eyewear device may be worn by an individual for use of the eyewear device and/or a system that is accessible by or is configured to otherwise interact with the eyewear device.

A system 103 may be comprised of computer hardware elements, all or some of which may be physically integrated within the eyewear device or a frame component or otherwise accessible by the eyewear device or an element thereof. For example, the eyewear device may include a hardware bus 104, through which other elements may exchange signals and data. One or more processors 105 may be included and may operate according to processor instructions 106, which may contribute to a definition of an architecture of the processor 105. Processor 105 may be configured to execute processor-executable instructions 108 that may be stored on one or more non-transitory machine-readable mediums 107. The processor-executable instructions 105 may be executable program code, and may be stored local to the eyewear device, remote to the eyewear device, or some combination of both. As a result of execution of processor-executable instruction 108, processor 105 may be configured to perform one or more tasks, operations, or methods associated with a use of the eyewear device and/or system, in whole or in part, alone or in cooperation with another eyewear device or system.

The eyewear device may include a display 113 and a speaker 114 for depicting graphical media and emitting sounds derived from audio media, respectively, and may include a microphone 115 for receiving or capturing audio from the wearer or the wearer's environment. The display 113 may be an AR display or a VR display, disposed on or about a left lens frame, on or about a right lens frame, or both. The eyewear device may accept one or more other input(s) 116, including but not limited to a haptic input, a touch input, or a movement input (e.g., from a motion detector or accelerometer), among others. The eyewear device may be powered by a power source 117, which may be a battery or a rechargeable battery or circuitry that is connectable to a source of direct current (DC) or alternating current (AC). The eyewear device may be configured to interact directly with network 111 via wireless interface 109 and/or may be configured to wirelessly interact with secondary device 110 and thereby indirectly access network 111 via network connection of secondary device 110.

The wireless interface may be comprised of any suitable wireless transmitter, receiver, or transceiver, and may utilize any suitable combination of wireless hardware, software, and wireless communication protocol, including but not limited to a Bluetooth® protocol, a WiFi® protocol, and an infrared (IR) protocol. While a wireless connection and interface is exemplarily shown, any other suitable connection and interface may be used without departing from the scope of the disclosure, including but not limited to wired connection (e.g., connections that involve one or more wires or cables) and wired interface (e.g., interfaces that involve one or more wired connections). In embodiments, the eyewear device may be configured to send a first set of data to the server, whether directly or indirectly via the secondary device, and receive a second set of data from the server, as an output of a function of the server.

Exemplary secondary devices include, but are not limited to, a mobile device, a tablet device, a personal computer, a gaming system, and an on-board navigation system. In various implementations, the eyewear device may be configured to send and receive data to and from a global positioning system (GPS) 112, respectively, whether directly via the eyewear device or indirectly via secondary device 110. If the eyewear device is configured for direct or indirect access to the internet, the eyewear device and/or the secondary device 110 may be configured to access remote server 118 for storage and retrieval of digital files and other media, including but not limited to images, videos, and audio, among others. Connections 119, 120, 121, 122, 123, 124, 125, 126, 127. 128, 129, and 130 may be wired and/or wireless, and may operate unidirectionally or bidirectionally depending on the elements connected and the protocol implemented for element intercommunication.

Other features that may be included with the eyewear device or system 103 include, but are not limited to, one or more flashlights (e.g., disposed on the device), one or more infrared (IR) sensors (e.g., disposed on the device), one or more motion sensors (e.g., disposed on or within the device), one or more global positioning system (GPS) components (e.g., disposed within the device), one or more personal safety functionalities, and any combination thereof. In this manner, the wearer may be able to view IR wavelengths of light, the modular eyewear device may be configured to detect motion, and/or the modular eyewear device may be configured to detect a global position utilizing the GPS component. It is envisioned that the modular eyewear device may include any component disposed thereon or therein which enhances or affects safety, vision, hearing, or cognitive processes such as spatial navigation. In this manner, the modular eyewear device may be configured for any of a variety of situations or scenarios. In embodiments, the server 118 may be a remote server, and the eyewear device may be configured for remote data capture and storage with the remote server 118. The modular eyewear device may be a part of a remote data capture and storage system, and/or the modular eyewear device may be configured for capturing data and storing the data remotely through use of a proxy connection to a data storage server or facility.

In embodiments, a function of the server 118 pertains to providing one or more communications, one or more notifications, and/or one or more pieces of information related to navigation to a wearer of the modular eyewear device. The server may enable more effective communication with other individuals, other wearers, or other servers (i.e., computational servers) when the wearer is navigating a space or area and may provide an augmented reality (AR) experience to the wearer. In this manner, the wearer may be better equipped to communicate, navigate, consume entertainment, or obtain information when going about these activities.

### IV. Eyewear Kits

The disclosure provides improved kits for storage and transport of modular eyewear frames and modular eyewear devices. Kits may include one or more sets of frame components that may be used with eyewear or eyewear devices, and containers may include pockets (e.g., indents, holes, or grooves) inset into a packaging material or surface for holding frame components as needed.

a. Storage Kits

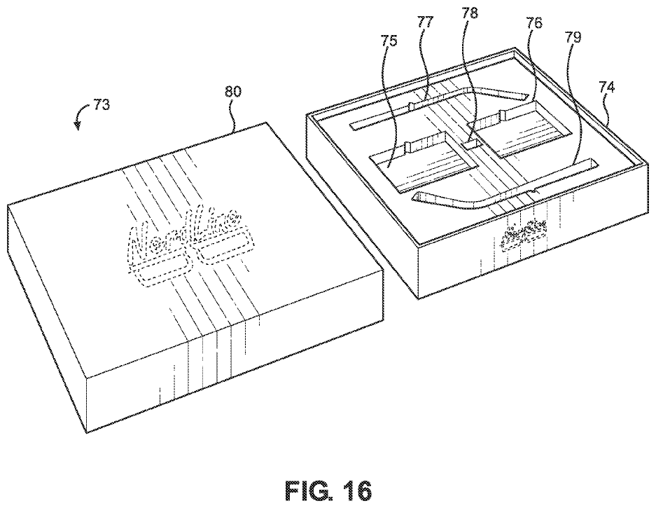

A perspective view of a first container for a first kit is shown at FIG. 16. A first container 73 for a first kit includes a base 74, a first lens frame pocket 75, a second lens frame pocket 76, a first temple pocket 77, a bridge pocket 78, a second temple pocket 79, and a cover 80. The cover 80 may slide over the base 74 to cover the other features in certain instances, such as during storage or transport of the first container 73. The first container 73 may be configured to hold one set of frame components for eyewear or an eyewear device, without any additional components such as alternate components.

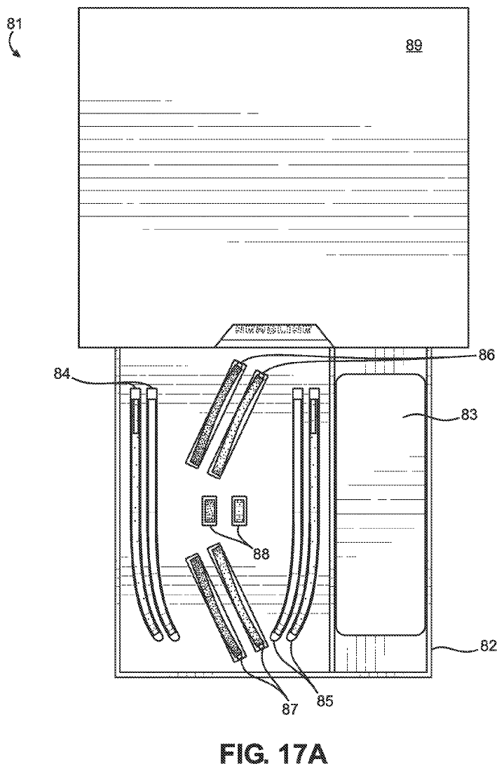

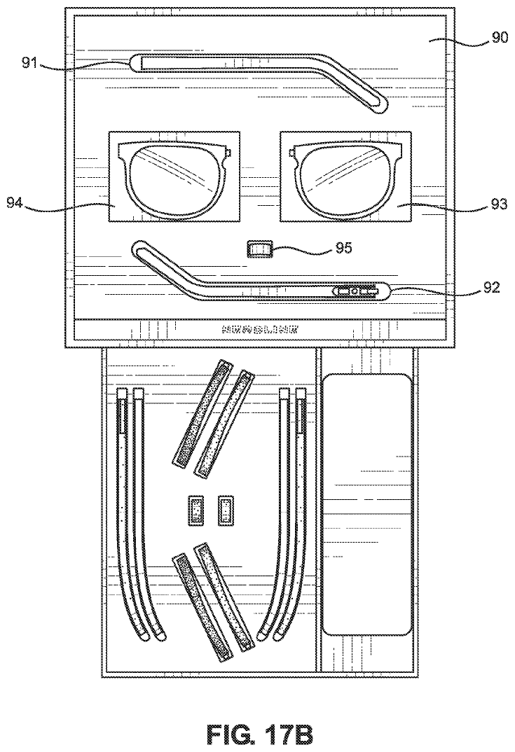

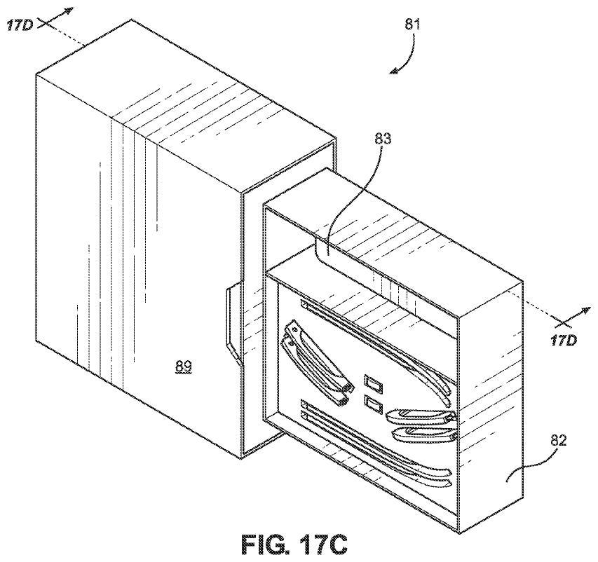

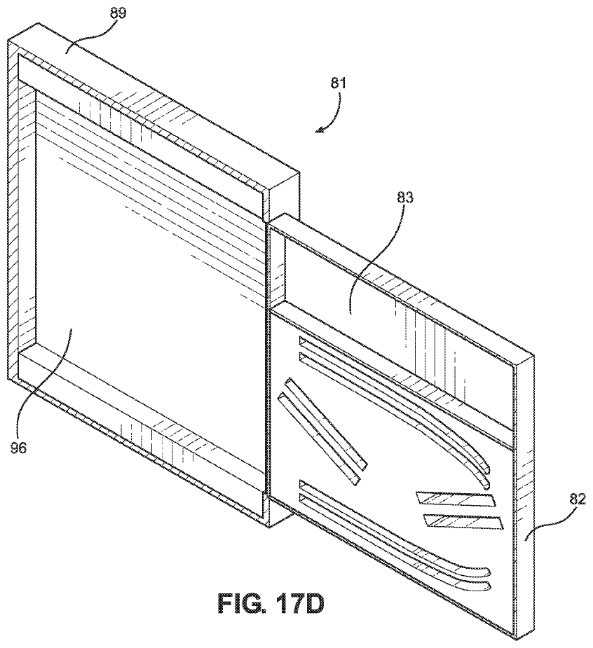

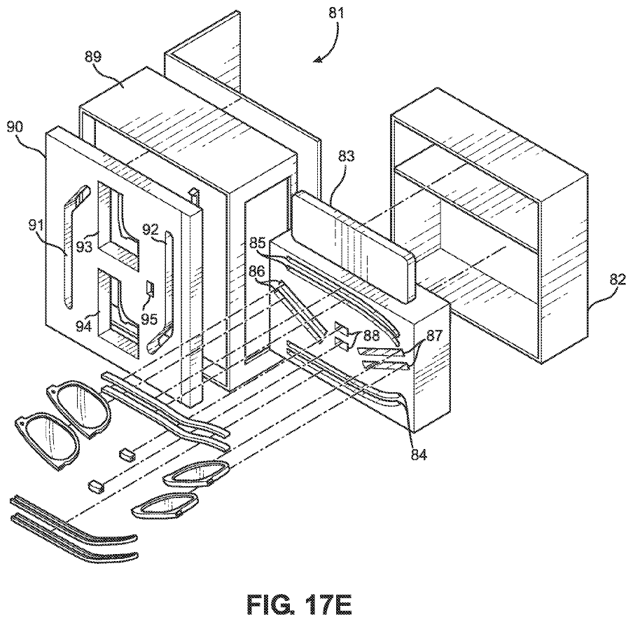

Other implementations of containers and kits may be configured to hold multiple sets of frame components. Referring now to FIGS. 17A, 17B, and 17C, there are shown a top view of a second container and a second kit, with a lower tray opened (FIG. 17A), a top view of the second container and the second kit, with the lower tray opened and an upper tray opened (FIG. 17B), a perspective view of the second container and the second kit, with the lower tray opened (FIG. 17C), a perspective cross-sectional view of the second container and the second kit, with the lower tray opened (FIG. 17D), and an exploded perspective view of the second container and the second kit (FIG. 17E). A second kit 81 includes a lower tray 82, a travel container 83, first alternate temples 84, second alternate temples 85, first alternate lens frames 86, second alternate lens frames 87, alternate center bridges 88, a cover 89, and an upper tray 90 that is concealable by the cover 89. The cover 89 may be removed to reveal the upper tray 90, which may be used to hold a first primary temple 91, a second primary temple 92, a first primary lens frame 93, a second primary lens frame 94, and a primary bridge 95. The primary components may be a default or first set of components for use with the frame, and the alternate components may be replacement or substitute or second components, one or more of which may be swapped out for corresponding primary components.

b. Travel Kits

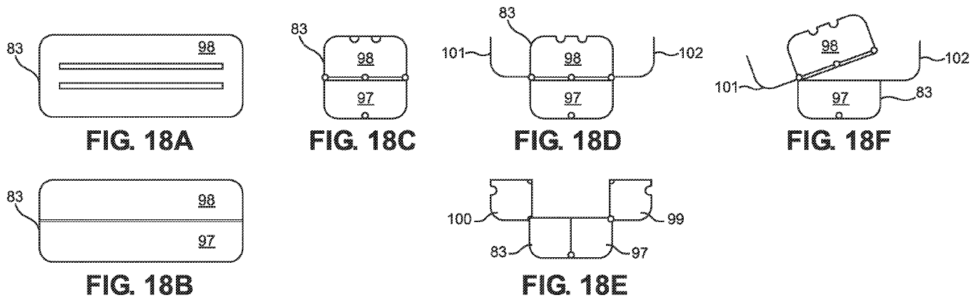

Referring now to FIGS. 18A, 18B, 18C, 18D, 18E, and 18F, there are shown a top view of a travel container of a kit of the present disclosure (FIG. 18A), a left side view of the travel container (FIG. 18B), a front side view of the travel container, with a lid in a closed configuration (FIG. 18C), a front side view of the travel container, with the lid in an open configuration (FIG. 18D), a front side view of a first alternate travel container, with a first alternate lid in a first alternate open configuration (FIG. 18E), and a front side view of a second alternate travel container, with a second alternate lid in a second alternate open configuration (FIG. 18F).

A travel container 83 may include a base 97 that engages a cover 98. The cover 98 may be covered by a first cover half shell 102 and a second cover half shell 101 that are configured to open and close about hinged connections to the base 97. Once the cover half shells 101, 102 are opened, the cover 98 may be opened about a hinge, as shown in FIGS. 18D and 18F. In other implementations, the cover may be comprised of a first cover half 99 and a second cover half 100, each of which may be configured to independently open and close about hinged connections to the base 97, as shown in FIG. 18E. The travel container 83 may be smaller and more compact compared to other containers and kits, and may be better configured to hold one set of frame components therein to facilitate storage and travel with the frame.

The foregoing descriptions of specific implementations have been presented for purposes of illustration and description. They are not intended to be exhaustive or to limit the invention to the precise forms disclosed, and modifications and variations are possible in view of the above teaching. The exemplary implementations were chosen and described to best explain the principles of the invention and its practical application, to thereby enable others skilled in the art to best utilize the invention and its implementations with modifications as suited to the use contemplated.

It is therefore submitted that the invention has been shown and described in the most practical and exemplary implementations. It should be recognized that departures may be made which fall within the scope of the invention. With respect to the description provided herein, it is submitted that the optimal features of the invention include variations in size, materials, shape, form, function, manner of operation, assembly, and use. All structures, functions, and relationships equivalent or essentially equivalent to those disclosed are intended to be encompassed by the invention.

1. An eyewear frame, comprising:
a first frame component and a second frame component that are reversibly connectable at a connection;
wherein the first frame component is connected to the second frame component at the connection and an external force is applied to the frame, the first frame component disconnects from the second frame component at the connection.

2. The frame of claim 1, wherein the external force is associated with an increased risk of damage to a different eyewear frame.

3. The frame of claim 1, wherein the external force is associated with an intentional disassembly of the frame.

4. The frame of claim 1, wherein the first frame component comprises a left lens frame, the second frame component comprises a right lens frame, and the connection comprises a bridge connection.

5. The frame of claim 4, further comprising a center bridge, wherein the bridge connection is an indirect connection between the left lens frame and the right lens frame via the center bridge.

6. The frame of claim 5, wherein the indirect connection comprises a left bridge connection between a left male member of the left lens frame and a left female acceptor of the center bridge and a right bridge connection between a right male member of the right lens frame and a right female acceptor of the center bridge.

7. The frame of claim 6, wherein the left male member and the left female acceptor are first magnetic complements configured for a first magnetic attraction therebetween and wherein the right male member and the right female acceptor are second magnetic complements configured for a second magnetic attraction therebetween.

8. The frame of claim 4, wherein the bridge connection is a direct connection between a left member of the left lens frame and a right member of the right lens frame, wherein the left member and the right member are magnetic complements configured for a magnetic attraction therebetween.

9. The frame of claim 8, wherein the magnetic attraction operates over a distance between the left member and the right member.

10. The frame of claim 4, wherein the bridge connection comprises a direct connection between a left male member of the left lens frame and a right female acceptor of the right lens frame, or a left female acceptor of the left lens frame and a right male member of the right lens frame; or
the bridge connection comprises an indirect connection between a grooved left male member of the left lens frame and a ribbed center bridge or a grooved right male member of the right lens frame and the ribbed center bridge.

11. The frame of claim 1, wherein the first frame component comprises a lens frame, the second frame component comprises a temple, and the connection is a temple connection.

12. The frame of claim 11, further comprising a temple stub that is hingedly attached to the lens frame, wherein the temple connection comprises an indirect connection between the lens frame and the temple via the temple stub.

13. The frame of claim 12, wherein the indirect connection comprises an engagement of the temple stub with a temple groove of the temple, wherein the temple stub and the temple groove are complementary to stabilize the engagement.

14. The frame of claim 13, wherein the temple stub and the temple groove are magnetically complementary to stabilize the engagement with a temple magnetic attraction.

15. An eyewear frame, comprising:
a left lens frame and a right lens frame that are reversibly connectable at a bridge connection;
a left temple stub that is hingedly attached to the left lens frame and includes a left temple connection; and
a right temple stub that is hingedly attached to the right lens frame and includes a right temple connection;
wherein the left lens frame is reversibly connected to the right lens frame at the bridge connection, the left temple stub is reversibly connected to a left temple at the left temple connection, and the right temple stub is reversibly connected to a right temple at the right temple connection, and wherein an external force is applied to the frame:
the left lens frame disconnects from the right lens frame at the bridge connection; the left temple stub disconnects from the left temple at the left temple connection; the right temple stub disconnects from the right temple at the right temple connection; or any combination thereof.

16. The frame of claim 15, further comprising a center bridge, wherein the bridge connection is an indirect connection between the left lens frame and the right lens frame via the center bridge;
wherein the indirect connection comprises a left bridge connection between a left male member of the left lens frame and a left female acceptor of the center bridge and a right bridge connection between a right male member of the right lens frame and a right female acceptor of the center bridge;
wherein the left male member and the left female acceptor are first magnetic complements configured for a first magnetic attraction therebetween and wherein the right male member and the right female acceptor are second magnetic complements configured for a second magnetic attraction therebetween.

17. The frame of claim 15, wherein the bridge connection is a direct connection between a left member of the left lens frame and a right member of the right lens frame, wherein the left member and the right member are magnetic complements configured for a magnetic attraction therebetween.

18. The frame of claim 15, wherein the left temple connection comprises a left indirect connection between the left lens frame and the left temple via the left temple stub, and wherein the right temple connection comprises a right indirect connection between the right lens frame and the right temple via the right temple stub;
wherein the left indirect connection comprises a left engagement of the left temple stub with a left temple groove of the left temple, wherein the left temple stub and the left temple groove are magnetically complementary to stabilize the left engagement with a left temple magnetic attraction;
wherein the right indirect connection comprises a right engagement of the right temple stub with a right temple groove of the right temple, wherein the right temple stub and the right temple groove are magnetically complementary to stabilize the right engagement with a right temple magnetic attraction.

19. An eyewear that comprises an eyewear frame of claim 1, an eyewear device that comprises an eyewear frame of claim 1, or an eyewear system that comprises an eyewear device that comprises an eyewear frame of claim 1.

20. A kit that comprises: an eyewear frame of claim 1, an eyewear that comprises an eyewear frame of claim 1, or an eyewear device that comprises an eyewear frame of claim 1.
